(19) United States
(12) Patent Application Publication
(10) Pub. No.: US 2020/0320560 A1
(43) Pub. Date: Oct. 8, 2020

(54) METHOD AND SYSTEM OF IMPLEMENTING SOCIAL NETWORK INCENTIVES FOR MOBILE DEVICE WIRELESS POWER TRANSFER

(71) Applicant: ZOE NICOLE SKERLOS, san diego, CA (US)

(72) Inventor: ZOE NICOLE SKERLOS, san diego, CA (US)

(21) Appl. No.: 16/373,604

(22) Filed: Apr. 2, 2019

(51) Int. Cl. G06Q 30/02; H02J 7/00; H02J 50/12; G06Q 50/00; H04W 4/029

(52) U.S. Cl. CPC G06Q 30/0208; H02J 7/00034; H04W 4/029; G06Q 50/01; H02J 50/12

(57) ABSTRACT

In one aspect, a computerized method for awarding karma points for wireless power transfer between mobile devices, includes the step of wirelessly coupling a wireless power transfer system of a first mobile device with a battery charging system of a second mobile device. The method includes the step of identifying a first user of the first mobile device. The method includes the step of identifying a second user of the second mobile device. The method includes the step of metering an amount of power transferred from the first mobile device to the second mobile device. The method includes the step of awarding an online account of the first user of the first mobile device karma points based on the metered value.

### CLAIM OF PRIORITY AND INCORPORATION BY REFERENCE

This application claims priority from U.S. Provisional Application No. 62/651,261, filed 2 Apr. 2018. These applications are hereby incorporated by reference in their entirety for all purposes.

### BACKGROUND

### 1. Field

This application relates generally to the mobile device wireless power transfer and, more specifically, to implementing social network incentives for mobile device wireless power transfer.

### 2. Related Art

Mobile devices utilize power from a battery source. If a mobile device is close to running out of battery power, the user may not be able to immediately find a power outlet for recharging the battery.

Additionally, users have begun to utilize mobile devices for a variety of activities such as surfing the Internet, text messaging, taking pictures/video, etc. As a result, battery usage has increased. Consequently, maintaining sufficient battery power has become a concern.

### SUMMARY

In one aspect, a computerized method for awarding karma points for wireless power transfer between mobile devices, includes the step of wirelessly coupling a wireless power transfer system of a first mobile device with a battery charging system of a second mobile device. The method includes the step of identifying a first user of the first mobile device. The method includes the step of identifying a second user of the second mobile device. The method includes the step of metering an amount of power transferred from the first mobile device to the second mobile device. The method includes the step of awarding an online account of the first user of the first mobile device karma points based on the metered value.

In another aspect, a computerized method for implementing social network incentives for mobile device wireless power transfer includes the step of providing a WPT-between-mobile-devices application in a user's mobile device. The method includes steps implemented with a wireless power transfer between mobile devices application. The method includes the step of determining that the mobile device needs a battery charge. The method includes the step of determining a user's current location. The method includes the step of accessing one or more online social networks utilized by the user. The method includes the step of querying the one or more online social networks for a list of nearby users that share a specified degree of relationship with the user. The method includes the step of identifying one or more potential contacts from the one or more online social networks, wherein the one or more potential contacts are within a specified distance from the user. The method includes the step of displaying a contact information about the one or more potential contacts. The method includes the step of using another instance of the WPT-between-mobile-devices application in another mobile devices of the one or more potential contacts to push requests for a wireless power transfer between the mobile device of the user and the other mobile devices.

### BRIEF DESCRIPTION OF THE DRAWINGS

The present application can be best understood by reference to the following description taken in conjunction with the accompanying figures, in which like parts may be referred to by like numerals.

FIG. 1 depicts an example system of wireless power transfer between two mobile devices, according to some embodiments.

FIG. 2 illustrates a system for managing Wireless power transfer applications in a set of mobile devices, according to some embodiments.

FIG. 3 is a block diagram of an example of a real-estate computing platform, according to some embodiments.

FIG. 4 is a block diagram of a sample computing environment that can be utilized to implement some embodiments.

FIG. 5 illustrates an example process for awarding karma points for wireless power transfer between mobile devices, according to some embodiments.

FIG. 6 illustrates an example process for identifying nearby candidates for wireless power transfer between mobile devices, according to some embodiments.

The Figures described above are a representative set and are not an exhaustive with respect to embodying the invention.

### DESCRIPTION

Disclosed are a system, method, and article of mobile device wireless power transfer and related incentives. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Inductive charging can use an electromagnetic field to transfer energy between two objects through electromagnetic induction. This is can be done with a charging station (e.g. such as a Qi-based system integrated into a mobile device cover, etc.). Energy is sent through an inductive coupling to an electrical device, which can then use that energy to charge batteries or run the device.

Mobile device is a computing device small enough to hold and operate in the hand. In some examples, a mobile device can have an LCD flatscreen interface, providing a touchscreen interface with digital buttons and keyboard or physical buttons along with a physical keyboard. a mobile device can connect to the Internet and interconnect with other devices such as car entertainment systems or headsets via Wi-Fi, Bluetooth, cellular networks or near field communication (NFC). A mobile device can include integrated cameras, digital media players, the ability to place and receive telephone calls, video games, and Global Positioning System (GPS) capabilities, etc. Power can be provided by a lithium battery. Mobile devices may run mobile operating systems that allow third-party apps specialized for said capabilities to be installed and run. It is noted that mobile devices can include external battery systems and wireless power transfer systems (e.g. for providing power to another mobile device and/or receiving power from another mobile device).

QI® is an open interface standard that defines wireless power transfer using inductive charging over distances of up to 4 cm (1.6 inches).

Online social networking service is an online platform which people use to build social networks or social relations with other people who share similar personal or career interests, activities, backgrounds or real-life connections. The social network is distributed across various computer networks. The social networks are inherently computer networks, linking people, organization, and knowledge.

Personal area network (PAN) is a computer network for interconnecting devices centered on an individual person's workspace. A PAN provides data transmission among devices.

Wireless power transfer (WPT) is the transmission of electrical energy without wires. Wireless power transmission technologies use time-varying electric, magnetic, or electromagnetic fields.

Exemplary Environment and Architecture

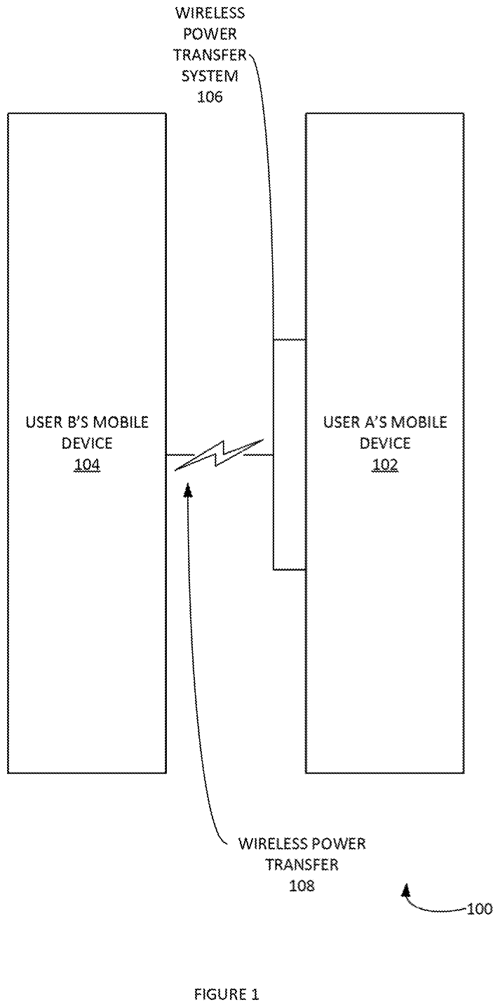

FIG. 1 schematically depicts an example system 100 of wireless power transfer between two mobile devices, according to some embodiments. System 100 can include two mobile devices (e.g. user A's mobile device 102, user B's mobile device 104, etc.). In some examples, the mobile device can include wireless power transfer system(s) 106. Wireless power transfer system(s) 106 can provide a wireless power transfer 108 between the two mobile devices.

In other examples, the wireless power transfer system 106 can be integrated within a mobile-device cover. Accordingly, the wireless power transfer system 106 can receive power from an external battery system (e.g. also integrated within the cover) and/or the internal power source of the mobile device.

As noted, wireless power transfer can transmission of electrical energy without wires. Wireless power transfer utilized, inter alia, inductive coupling, resonant inductive coupling, capacitive coupling, magnetodynamic coupling, microwaves, light waves, etc.

In one example, wireless power transfer system 106 can include a Qi-based system. The Qi-based system can include an inductive charging pad for a smartphone. The Qi-based system can implement a near-field wireless transfer. For example, user A's mobile device 102 can include a Qi-based system. When user B's mobile device 104 is set on the Qi-based system's pad, a coil in the pad creates a magnetic field which induces a current in another coil charging the battery of user B's mobile device 104. In one example, the Qi-based system can be integrated into a cover a user A's mobile device 102.

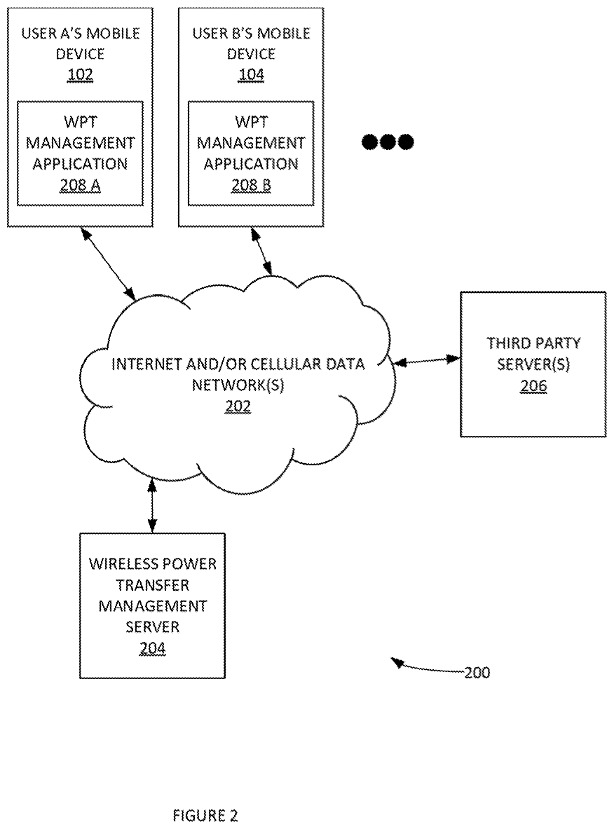

A mobile device can be, inter alia, a smart phone, a smart watch, wireless BLUETOOTH® earbuds, tablet computers, etc. The mobile device can include a wireless power transfer (WPT) application (see FIG. 2 infra) for monitoring wireless power transfer operations of the mobile device.

FIG. 2 illustrates a system 200 for managing Wireless power transfer applications in a set of mobile devices, according to some embodiments. System 200 can include mobile devices 102 and 104 (as previously presented in FIG. 1).

As noted, mobile devices 102 and 104 can include wireless power transfer applications 208 A-B. Wireless power transfer (WPT) applications 208 A-B can monitor wireless power transfer operations of a mobile device. WPT applications 208 A-B can monitor a mobile devices current battery usage (e.g. internal and/or external batteries, etc.). WPT application can monitor the amount of power wirelessly transferred to other mobile devices. WPT applications 208 A-B can determine and record the identities of other mobile devices (as well as the user identity) that receive wireless power transfers. WPT applications 208 A-B can determine and record various other relevant metadata related to a wireless power transfer (e.g. time, date, online social network information of users, etc.). WPT applications 208 A-B can communicate with a cloud-based and/or other server system such as WPT management server 204.

WPT management server 204 can manage the rewarding of credits (e.g. ‘karma’ points) to users who provide a mobile device for WPT charging of other user's mobile devices.

Additionally, WPT management server 204 can include a database management system and a database for recording data related to WPT applications 208 A-B. WPT management server 204 can maintain an online WPT social network for users. The online WPT social network can enable users to identify other users with WPT systems in their mobile devices. The online WPT social network can enable users locate (e.g. via an online mapping service application) other users with WPT enabled mobile devices. The online WPT social network can enable users to leave ratings for other users, as well as, view karma points previously awarded to other users. The online WPT social network can enable users to redeem karma points for various other goods/services (e.g. online music subscription payments, other online payments, cryptocurrencies, digital payments, etc.).

The online WPT social network can enable users to register with the online WPT social network. Users can create profiles and provide WPT-related charging conditions. In some examples, users can set fees/rates for providing WPT services with their mobile devices. These fees can be charged via an online e-commerce system, mobile payment system, etc. The online WPT social network can interface (e.g. via applicable API's) with other online social networks and/or microblogging services (e.g. Facebook®, Instagram®, Twitter®, etc.). In this way, a user's activity within the online WPT social network can be ported to posts, status updates and the like across the user's other online social network profiles.

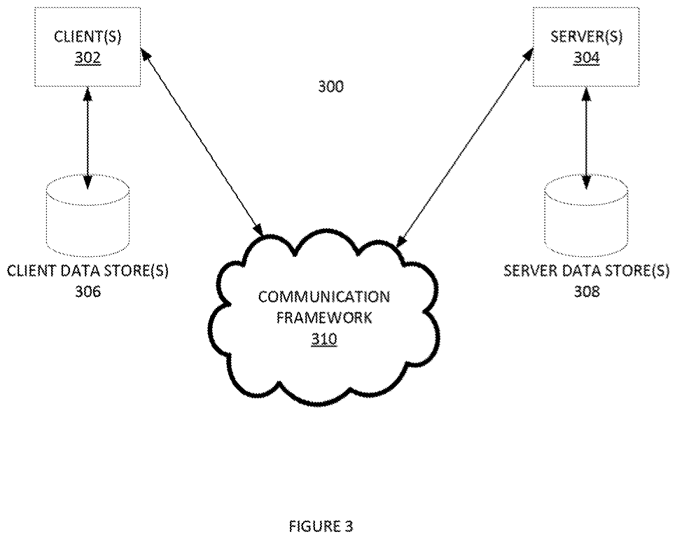

FIG. 3 is a block diagram of a sample computing environment 300 that can be utilized to implement some embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304.

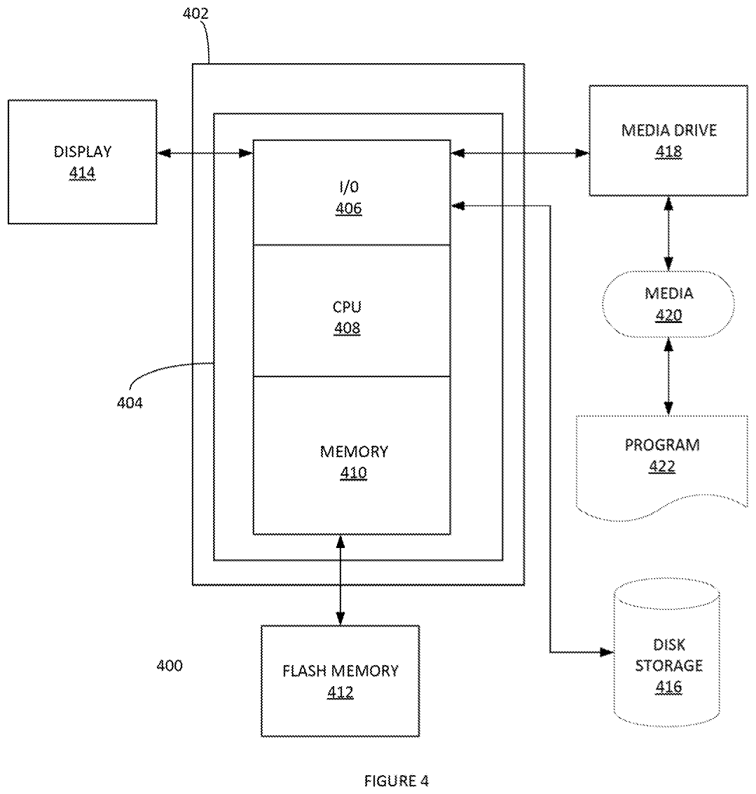

FIG. 4 depicts an exemplary computing system 700 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. In another example, computing system 400 can be configured as a mobile device and include such systems as may be typically included in a mobile device such as GPS systems, gyroscope, accelerometers, cameras, etc.

Example Processes

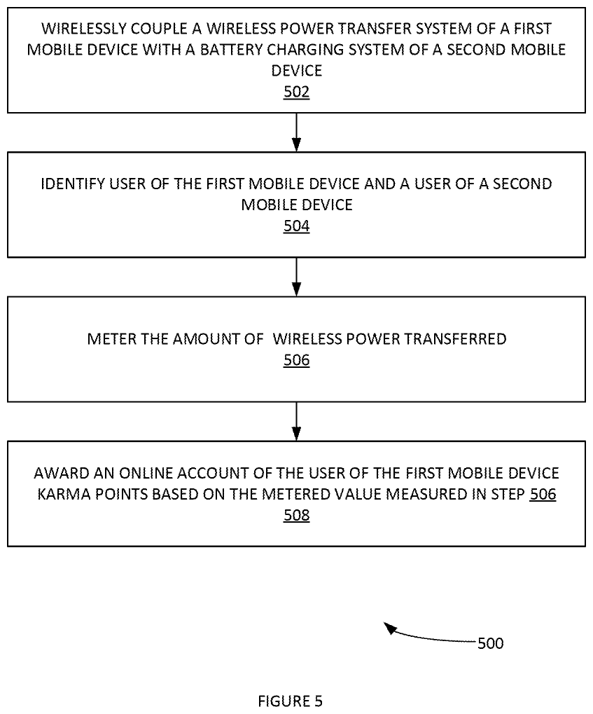

FIG. 5 illustrates an example process 500 for awarding karma points for wireless power transfer between mobile devices, according to some embodiments. In step 502, process 500 can wirelessly couple a wireless power transfer system of a first mobile device with a battery charging system of a second mobile device. In step 504, process 500 can identify the user of the first mobile device and the user of a second mobile device. This can be implemented by coupling the two mobile devices via Bluetooth®, determining the geo-location of each mobile device, manual user input, etc. In step 506, process 500 can meter the amount of power transferred from the first mobile device to the second mobile device. In step 508, process 500 can award an online account of the user of the first mobile device karma points based on the metered value measured in step 506.

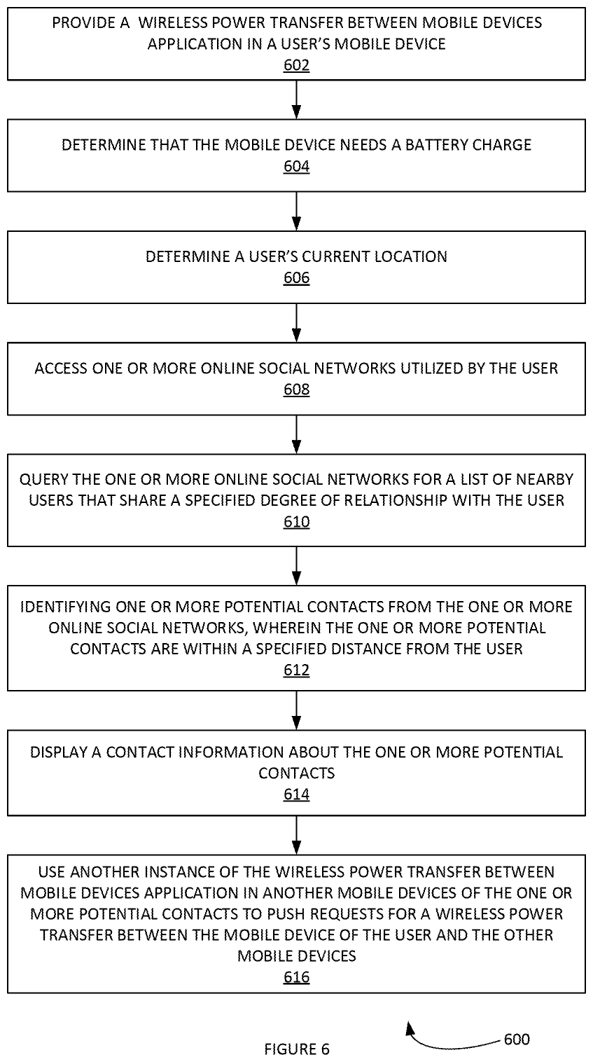

FIG. 6 illustrates an example process for identifying nearby candidates for wireless power transfer between mobile devices, according to some embodiments. In step 602, a WPT-between-mobile-devices application can be provided in a user's mobile device. In step 604, the WPT-between-mobile-devices application can determine that the mobile device needs a battery charge. In step 606, the WPT-between-mobile-devices application can determine the user's current location. In step 608, the WPT-between-mobile-devices application can access one or more online social network utilized by the user.

In step 610, the WPT-between-mobile-devices application query the one or more online social networks for a list of nearby users that share a specified degree of relationship with the user (e.g. friends, past interactions, friends of friends, common interests, historical relationships, alma maters, common interests, etc.). The user can set the parameters of the search by the wireless power transfer between mobile devices application. The parameters can include which online social-network services can be accessed. For example, the WPT-between-mobile-devices application can access socializing social network services used primarily for socializing with existing friends (e.g., Facebook). Online social networks are decentralized and distributed computer networks where users communicate with each other through internet services. The WPT-between-mobile-devices application can access networking social network services used primarily for non-social interpersonal communication (e.g., LinkedIn, a career- and employment-oriented site) social navigation social network services used primarily for helping users to find specific information or resources (e.g., Goodreads for books).

In step 612, the WPT-between-mobile-devices application can identify one or more potential contacts based on output of step 610. In step 614, the WPT-between-mobile-devices application can display the picture, name and other information of the possible contacts to the user. In 616, the WPT-between-mobile-devices application can use instances of the WPT-between-mobile-devices application in the mobile devices of the potential contacts to push requests for a wireless power transfer between mobile devices.

For example, a user can be at a café. The user's mobile device can go below a battery charge of five percent. The WPT-between-mobile-devices application can search and detect that the friend of a Facebook® friend is also in the café. The WPT-between-mobile-devices application can push an introduction and request to the friend of the Facebook® friend. The user can be notified that the request was accepted. The user can approach the friend of a Facebook® friend and the two mobile devices can be coupled for the wireless power transfer between mobile devices. The friend of a Facebook® friend can then be awarded Karma points, receive monetary credits, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized method for awarding karma points for wireless power transfer between mobile devices, comprising:
wirelessly coupling a wireless power transfer system of a first mobile device with a battery charging system of a second mobile device;
identifying a first user of the first mobile device;
identifying a second user of the second mobile device;
metering an amount of power transferred from the first mobile device to the second mobile device; and
awarding an online account of the first user of the first mobile device karma points based on the metered value.

2. The method of claim 1, further comprising:
communicatively coupling the first mobile device and the second mobile device via a wireless technology standard for exchanging data using short-wavelength UHF radio waves.

3. The method of claim 2, wherein the wireless technology standard comprises a BLUETOOTH® connection.

4. The method of claim 1, wherein the step of identifying the first user of the first mobile device and the second user of a second mobile device further comprises:
determining a first geo-location of the first mobile device; and
determining a second geo-location of the second mobile device.

5. A computerized method for implementing social network incentives for mobile device wireless power transfer comprising:
providing a WPT-between-mobile-devices application in a user's mobile device;
with a wireless power transfer between mobile devices application:
determining that the mobile device needs a battery charge;
determining a user's current location;
accessing one or more online social networks utilized by the user;
querying the one or more online social networks for a list of nearby users that share a specified degree of relationship with the user;
identifying one or more potential contacts from the one or more online social networks, wherein the one or more potential contacts are within a specified distance from the user;
displaying a contact information about the one or more potential contacts; and
using another instance of the WPT-between-mobile-devices application in another mobile devices of the one or more potential contacts to push requests for a wireless power transfer between the mobile device of the user and the other mobile devices.

6. The computerized method of claim 5, wherein the contact information comprises a digital photograph of one or more potential contacts.

7. The computerized method of claim 6, wherein the contact information comprises a name of one or more potential contacts.

8. The computerized method of claim 7, wherein the contact information comprises a list of the social network connections between the user and the one or more potential contacts.

9. The computerized method of claim 8 further comprising:
metering an amount of power transferred from the first mobile device to the second mobile device; and

10. The computerized method of claim 9 further comprising:
awarding an online account of the first user of the first mobile device karma points based on the metered value.
